(19) United States
(12) Patent Application Publication
(10) Pub. No.: US 2026/0155113 A1
(43) Pub. Date: Jun. 4, 2026

(54) DISPLAY IMAGE COMPENSATION DEVICE AND COMPENSATION METHOD THEREOF

(71) Applicant: HIMAX TECHNOLOGIES LIMITED, Tainan City (TW)

(72) Inventor: Tung-Ying Wu, Tainan City (TW)

(73) Assignee: HIMAX TECHNOLOGIES LIMITED, Tainan City (TW)

(21) Appl. No.: 18/967,538

(22) Filed: Dec. 3, 2024

(51) Int. Cl. G09G 5/02

(52) U.S. Cl. CPC G09G 5/02; G09G 2300/0819; G09G 2320/0233; G09G 2320/0242; G09G 2320/0285; G09G 2320/045; G09G 2360/16

(57) ABSTRACT

A display image compensation device includes a signal receiver, an offset information generator and a color value compensator. The signal receiver receives a display image. The first offset information generator, coupled to the signal receiver, based on a first selected color, generates first color offset information according to each of a plurality of gray levels of the display image corresponding to the first selected color. The color value compensator generates each of a plurality of compensated gray levels by adjusting each of the gray levels of the display image according to the first color offset information.

### BACKGROUND

### Technical Field

The disclosure relates to a display image compensation device and compensation method thereof, and more particularly, to the display image compensation device which can perform color shifting de-mura on a display image.

### Description of Related Art

Please refer to FIG. 1A, FIG. 1B and FIG. 1C, which illustrate relationship diagrams between wave lengths and gray levels in different display areas. In each of FIGS. 1A to 1C, the vertical axis illustrates a wavelength of display light of a display pixel, and a horizontal axis illustrates a driving current on the display pixel. In FIG. 1A, red light display pixels are disposed in different areas A to C, and the wavelengths of the display lights by the display pixels in the areas A to C are different. Furthermore, when the gray levels of the display pixels in the areas A to C are increased according to the increasing driving current, the differences between the wavelengths of the display lights by the display pixels in different areas A to C are enlarged. In FIG. 1B to FIG. 1C, display light of green light display pixels and blue light display pixel in different areas A to C are also varied according to the corresponding driving current. Such as that, a color shifting phenomenon can be induced.

### SUMMARY

The disclosure provides a display image compensation device and compensation method thereof for performing color shifting de-mura operation on display image.

The display image compensation device includes a signal receiver, an offset information generator and a color value compensator. The signal receiver receives a display image. The first offset information generator, coupled to the signal receiver, based on a first selected color, generates first color offset information according to each of a plurality of gray levels of the display image corresponding to the first selected color. The color value compensator generates each of a plurality of compensated gray levels by adjusting each of the gray levels of the display image according to the first color offset information.

The display image compensation method includes: receiving a display image; based on a first selected color, generating first color offset information by a first offset information generator according to each of a plurality of gray levels of the display image corresponding to the first selected color; and generating, by a color value compensator, each of a plurality of compensated gray levels by adjusting each of the gray levels of the display image according to the first color offset information.

Based on the above, the display image compensation device of presented disclosure provides an offset information generator to generate color offset information according to each gray level of the display image corresponding to the selected color, and generate each compensated gray level by adjusting each gray level of the display image according to corresponding color offset information. Such as that, a color shifting phenomenon can be compensated by adjusting each gray level of each pixel of a display according to a value of each gray level.

### BRIEF DESCRIPTION OF THE DRAWINGS

FIG. 1A, FIG. 1B and FIG. 1C illustrate relationship diagrams between wave lengths and gray levels in different display areas.

FIG. 2 illustrates a schematic diagram of a display image compensation device according to an embodiment of present disclosure.

FIG. 3, which illustrates a schematic diagram of a display image compensation device according to another embodiment of present disclosure.

FIG. 4 illustrates a schematic diagram of a display image compensation device according to another embodiment of present disclosure.

FIG. 5 illustrates a schematic diagram of the offset information generator according to an embodiment of present disclosure.

FIG. 6 illustrates a flow chart for generating the relationships between color offset information and gray levels of selected color according to an embodiment of present disclosure.

FIG. 7 illustrates a flow chart for performing image compensation according to an embodiment of present disclosure.

FIG. 8 illustrates a flow chart of display image compensation method according to an embodiment of present disclosure.

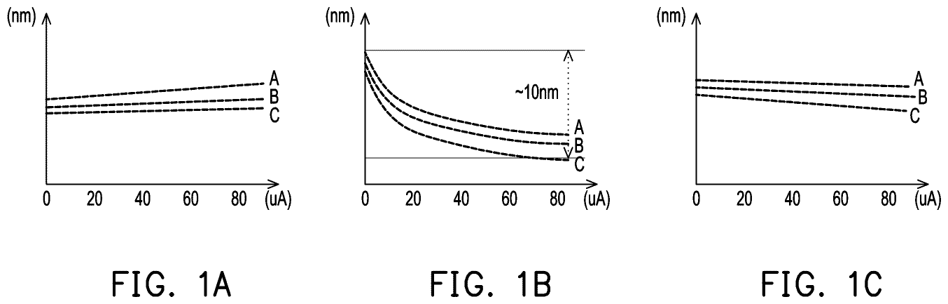

### DETAILED DESCRIPTION OF DISCLOSED EMBODIMENTS

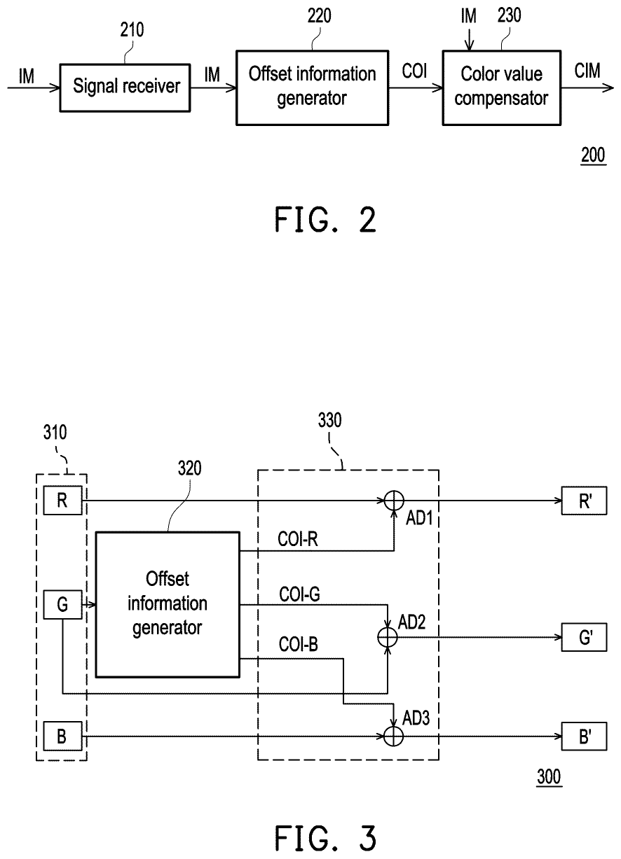

Please refer to FIG. 2, which illustrates a schematic diagram of a display image compensation device according to an embodiment of present disclosure. The display image compensation device 200 may be implemented in a display device, and may be configured to compensate a display image of a display panel of the display device. The display image compensation device 200 includes a signal receiver 210, an offset information generator 220 and a color value compensator 230. The signal receiver 210 is configure to receive a display image IM. The offset information generator 220 is coupled to the signal receiver 210. The offset information generator 220 receives the display image IM, and is configured to, based on a selected color, generate color offset information COI according to each of a plurality of gray levels of the display image IM corresponding to the selected color. In detail, in one embodiment, the selected color may be green. The offset information generator 220 may generate the color offset information COI corresponding to a gray level of a green part of each pixel image of the received display image IM. The color offset information COI corresponding to each pixel image may include three color offset values, and the three color offset values are respectively corresponding to different display colors, such as red, green and blue.

In some embodiment, the offset information generator 220 may be implemented by a look-up table. For example, the look-up table may be shown as table 1:

TABLE 1

| Gray level | Red | Green | Blue |
|---|---|---|---|
| 255 | 76 | −2 | 13 |
| 224 | 63 | −3 | 15 |
| 192 | 45 | −4 | 15 |
| 160 | 32 | −3 | 14 |
| 128 | 20 | −4 | 12 |
| 96 | 13 | −7 | 12 |
| 64 | 9 | −13 | 11 |
| 32 | 4 | −12 | 9 |
| 16 | 0 | −5 | 5 |
| 8 | 0 | −1 | 3 |

By referring to the table 1, if the gray level of the green part of the pixel image is 255. The offset information generator 220 may generate the color offset information COI including a red color offset value=76, a green color offset value=−2, and a blue color offset value=13. Furthermore, if the gray level of the green part of the pixel image is 128. The offset information generator 120 may generate the color offset information COI including the red color offset value=20, the green color offset value=−4, and the blue color offset value=12.

The color value compensator 230 is coupled to the offset information generator 220. The color value compensator 230 receives the color offset information COI and the display mage IM. The color value compensator 230 is configured to generate each of a plurality of compensated gray levels CIM by adjusting each of the gray levels of the display image IM according to the color offset information COI.

For example, inheriting the examples mentioned above, if the gray level of the green part of the pixel image is 255, and gray levels of a red part and blue part are respectively R0 and B0. The uncompensated gray level may be equal to R (0)+G (255)+B(0). The offset information generator 120 may generate the color offset information COI including color offset values=(76, −2, 13), and the color value compensator 130 may generate compensated gray level CIM corresponding to the pixel image, and the compensated gray level CIM=R (0+76)+G (255−2)+B (0+13)=R (76)+G (253)+B(13).

In the table 1, not all possible gray levels of the green part of the pixel image are recorded in the table 1. The table 1 merely records a plurality defined gray levels and corresponding color shift information. The defined gray levels are parts of all possible gray levels of the pixel image. In some embodiments of present disclosure, the look-up table of the offset information generator 120 may be implemented by memory device. By merely records the defined gray levels in the look-up table, a size of the memory device can be saved.

If the gray level of the green part of the pixel image is not found in the table 1 during a look-up operation, the offset information generator 220 may select two gray levels closest to the gray level, and output a first selected color offset information and a second selected color offset information respectively corresponding the two gray levels. For example, if the gray level of the green part of the pixel image is 185, the offset information generator 220 may select the gray levels 192 and 160, and output the first selected color offset information (with color shift values 45, −4 and 15) and the second selected color offset information (with color shift values 32, −3 and 14) respectively corresponding the two gray levels 192 and 160. Moreover, the color value compensator 130 may be configured to generate the corresponding compensated gray level CIM by firstly performing interpolation operation on the first selected color offset information and the second selected color offset information to generated an interpolated color offset information, and then generate the corresponding compensated gray level CIM according to the interpolated color offset information and the display image IM.

It should be noted here, in some embodiments, one or more offset information generators may be implemented in the display image compensation device 200. For example, if there are two offset information generators are implemented in the display image compensation device 200, two colors may be the selected colors. For example, green and blue are the two selected colors; green and red are the two selected colors; or blue and red are the two selected colors.

Of course, in some embodiments, all possible gray levels of the green part of the pixel image may be recorded in the look-up table when the size of the memory device is large enough. In this embodiment, the interpolation operation is not necessary for the color value compensator 230.

On the other hand, in some embodiments, the offset information generator 220 may include a plurality of offset information sub-generators, and the offset information sub-generators are respectively corresponding to a plurality display areas of the display device.

Please refer to FIG. 3, which illustrates a schematic diagram of a display image compensation device according to another embodiment of present disclosure. The display image compensation device 300 includes a signal receiver 310, an offset information generator 320 and a color value compensator 330. The signal receiver 310 receives a display image including red part image R, green part image G and blue part image B. The green part image G may be transmitted to the offset information generator 320, and the offset information generator 320 generates color offset information including a red color offset value COI-R, a green color offset value COI-G, and a blue color offset value COI-B. The offset information generator 320 provides the red color offset value COI-R, the green color offset value COI-G, and the blue color offset value COI-B to the color value compensator 330. The color value compensator 330 includes a plurality of arithmetic circuits AD1 to AD3. In this embodiment, the arithmetic circuits AD1 to AD3 may be adders. The arithmetic circuit AD1 receives the red color offset value COI-R and the red part image R, and generates a compensated red gray level R′ by adding the red color offset value COI-R and the red part image R. The arithmetic circuit AD2 receives the green color offset value COI-G and the green part image G, and generates a compensated green gray level G′ by adding the green color offset value COI-G and the green part image G. The arithmetic circuit AD3 receives the blue color offset value COI-B and the blue part image B, and generates a compensated blue gray level B′ by adding the blue color offset value COI-B and the blue part image B.

In this embodiment, the offset information generator 320 may include a look-up table and corresponding to a selected color which is green. The offset information generator 320 may record relationships between all possible gray levels of the green part image G with the color offset compensation information. Such as that, the offset information generator 320 may provide the red color offset value COI-R, the green color offset value COI-G, and the blue color offset value COI-B to the color value compensator 330 directly according to a gray level of the received green part image G.

On the other hand, the look-up table of the offset information generator 320 may be implemented by a memory device, such as a flash memory device or any other non-volatile or volatile memory device. The arithmetic circuits AD1 to AD3 may be implemented by any digital adding circuit well known by a person skilled in the art, and no more special limitation here.

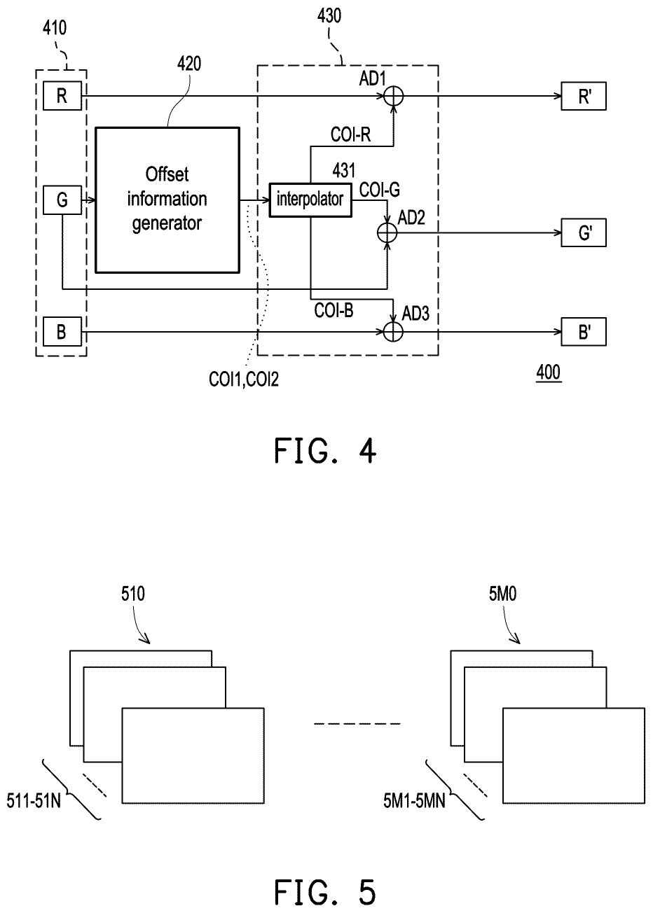

Please refer to FIG. 4, which illustrates a schematic diagram of a display image compensation device according to another embodiment of present disclosure. The display image compensation device 400 includes a signal receiver 410, an offset information generator 420 and a color value compensator 430. The signal receiver 410 receives a display image including red part image R, green part image G and blue part image B. The green part image G may be transmitted to the offset information generator 420, and the offset information generator 420 may generate a first selected color offset compensation information COI1 and a second selected color offset compensation information COI2 according to the received green part image G. The offset information generator 420 may provide the first selected color offset compensation information COI1 and the second selected color offset compensation information COI2 to the color value compensator 430.

It should be noted here, for decreasing a circuit size of the offset information generator 420, a look-up table of the offset information generator 420 may merely record relationships between color offset information corresponding to a plurality of defined gray levels of the selected color, where number of the defined gray levels is smaller than number of all possible gray levels of the selected color. The offset information generator 420 may select two defined gray levels which are closest to a gray level of the green part image G to respectively generate the first selected color offset compensation information COI1 and the second selected color offset compensation information COI2.

In this embodiment, the color value compensator 430 includes a plurality of arithmetic circuits AD1 to AD3 and an interpolator 431. The interpolator 431 receives the first selected color offset compensation information COI1 and the second selected color offset compensation information COI2, and perform an interpolation operation on the first selected color offset compensation information COI1 and the second selected color offset compensation information COI2 to generate a red color offset value COI-R, a green color offset value COI-G, and a blue color offset value COI-B. The arithmetic circuits AD1 to AD3 may be adders, and the arithmetic circuits AD1 to AD3 and an interpolator 431 may be implemented by digital circuits.

Please refer to FIG. 5, which illustrates a schematic diagram of the offset information generator according to an embodiment of present disclosure. In a display image compensation device, one offset information generator 510 can be disposed for generating color offset compensation corresponding a first selected color. The offset information generator 510 may include a plurality of offset information sub-generators 511 to 51N, and each of the offset information sub-generators 511 to 51N is a look-up table. The offset information sub-generators 511 to 51N are respectively corresponding to a plurality display areas of a display device. Such as that, the offset information generator 510 of present disclosure may provide different color offset information corresponding to different display areas.

In some embodiments, more offset information generators 510 to 5M0 may be implemented in the display image compensation device. The offset information generators 510 to 5M0 respectively corresponding to a plurality of selected colors. For example, the offset information generator 5M0 may be corresponding to a second selected color, where the first selected color may be green and the second selected color may be red or blue. The offset information generator 5M0 may include a plurality of offset information sub-generators 5M1 to 5MN. The offset information sub-generators 5M1 to 5MN are respectively corresponding to the display areas of the display device.

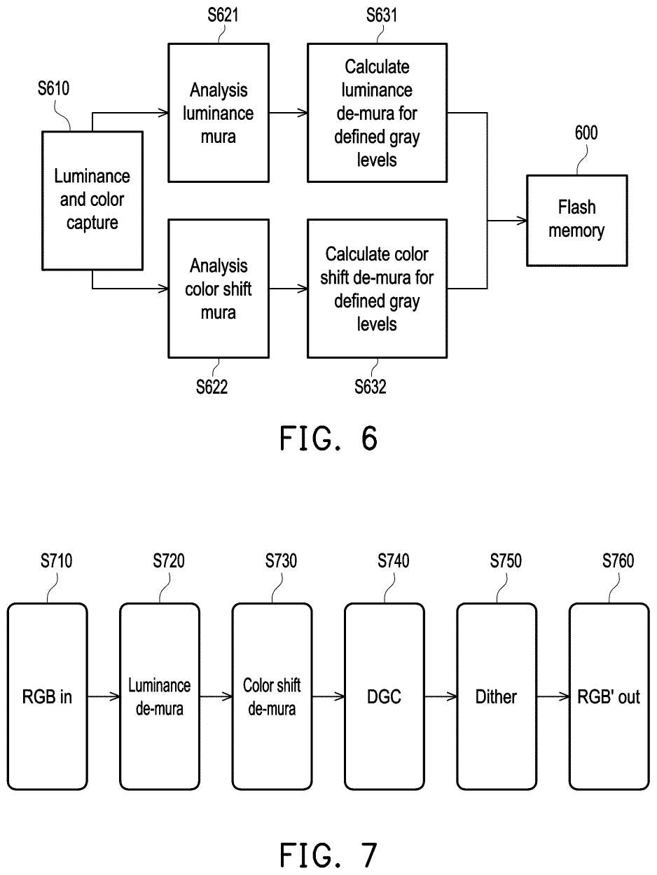

Please refer to FIG. 6, which illustrates a flow chart for generating the relationships between color offset information and gray levels of selected color according to an embodiment of present disclosure. In a step S610, a luminance and color capturing operation may be performed on a display device. Certain display pattern or color may be displayed by the display device, and engineer may capture information of luminance and color during the operation. For example, the display pattern with at least one of red, green, and blue colors can be set, and gray level of the display pattern may be at least one of 64, 128, 194 and 255. In steps S621 and S622, a luminance mura analysis and a color shift mura analysis may be performed, respectively. According to analysis results, in steps S631 and S632, a luminance de-mura calculation and a color shift de-mura calculation for defined gray levels can be performed. The defined gray levels may be set by engineer. Number of the defined gray levels may be defined according to a size of a memory for implementing a look-up table of the offset information generator. In the steps S631 and S632, luminance offset values and color offset values can be obtained, and the luminance offset values and color offset values can be stored in a flash memory 600. In this embodiment, the flash memory 600 may be the look-up table of the offset information generator by providing the color offset values corresponding to gray levels of a selected color of a display image.

Please refer to FIG. 7, which illustrates a flow chart for performing image compensation according to an embodiment of present disclosure. In a step S710, a display image RGB can be inputted. In a step S720, a luminance de-mura operation on the display image RGB can be performed. In a step S730, a color shift de-mura operation on the display image RGB can be performed. Then, in a step S740, a digital gamma correction (DGC) operation may be performed, and in a step S750, a dither operation may be performed. Finaly, in a step S760, a compensated display data RGB′ can be outputted for image display operation.

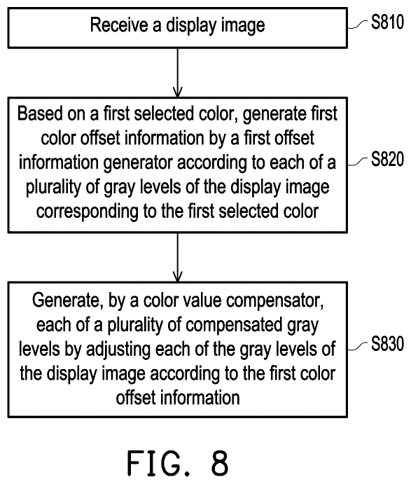

Please refer to FIG. 8, which illustrates a flow chart of display image compensation method according to an embodiment of present disclosure. In a step S810, an image data may be received by a display image compensation device. In a step S820, first color offset information may be generated, based on a first selected color, by a first offset information generator according to each of a plurality of gray levels of the display image corresponding to the first selected color. Then, in a step S830, each of a plurality of compensated gray levels may be generated, by a color value compensator, by adjusting each of the gray levels of the display image according to the first color offset information.

Detail operations of the steps S810 to S830 have been detail described in the embodiments mentioned above, and no more repeated description here.

In summary, the display image compensation device of presented disclosure provides an offset information generator to generate color offset information according to each gray level of the display image corresponding to the selected color. The display image compensation device further adjusts gray levels of green part, blue part and red part according to corresponding color offset information according to the color offset information. Such as that, a color shifting phenomenon can be compensated by adjusting each gray level of each pixel of a display according to a value of each gray level.

1. A display image compensation device, comprising:
a signal receiver, receiving a display image;
a first offset information generator, coupled to the signal receiver, based on a first selected color of the display image, generating first color offset information corresponding to a gray level of the selected color according to each of a plurality of gray levels of the display image, wherein the first color offset information corresponding to the gray level of the selected color includes different color offset values, respectively corresponding to different display colors; and
a color value compensator, generating each of a plurality of compensated gray levels by adjusting each of the gray levels of the display image according to the first color offset information.

2. (canceled)

3. The display image compensation device according to claim 1, wherein the first offset information generator comprises:
a look-up table, for storing the first color offset information corresponding to a plurality of defined gray levels of the first selected color.

4. The display image compensation device according to claim 3, wherein the look-up table is implemented in a memory device.

5. The display image compensation device according to claim 1, wherein the color value compensator comprises:
a plurality of arithmetic circuits, generating each of a plurality of compensated gray levels by adding each of the gray levels of the display image with the corresponding first color offset information.

6. The display image compensation device according to claim 1, wherein the color value compensator comprises:
an interpolator, performing an interpolation operation on first selected color offset information and second selected color offset information to generate an interpolated color offset information; and
a plurality of arithmetic circuits, generating each of a plurality of compensated gray levels by adding each of the gray levels of the display image with the interpolated color offset information.

7. The display image compensation device according to claim 6, wherein each of the arithmetic circuits is an adder.

8. The display image compensation device according to claim 1, wherein the first selected color is green.

9. The display image compensation device according to claim 1, further comprising:
a second offset information generator, coupled to the signal receiver, based on a second selected color, generating second color offset information according to each of a plurality of gray levels of the display image corresponding to the second selected color,
wherein the color value compensator generating each of the plurality of compensated gray levels by adjusting each of the gray levels of the display image according to the corresponding first color offset information and the second color offset information.

10. The display image compensation device according to claim 1, wherein the first offset information generator comprises a plurality of offset information sub-generators, the offset information sub-generators are respectively corresponding to a plurality of display areas of a display device.

11. A display image compensation method, comprising:
receiving a display image;
based on a first selected color of the display image, generating first color offset information corresponding to a gray level of the selected color by a first offset information generator according to each of a plurality of gray levels of the display image, wherein the first color offset information corresponding to the gray level of the selected color includes different color offset values, respectively corresponding to different display colors; and
generating, by a color value compensator, each of a plurality of compensated gray levels by adjusting each of the gray levels of the display image according to the first color offset information.

12. (canceled)

13. The display image compensation method according to claim 11, further comprising:
providing a look-up table to implement the first offset information generator for storing the first color offset information corresponding to a plurality of defined gray levels of the first selected color.

14. The display image compensation method according to claim 11, wherein step of generating, each of a plurality of compensated gray levels by adjusting each of the gray levels of the display image according to corresponding color offset information comprises:
generating each of a plurality of compensated gray levels by adding each of the gray levels of the display image with the first color offset information by a plurality of arithmetic circuits.

15. The display image compensation method according to claim 11, wherein step of generating, each of a plurality of compensated gray levels by adjusting each of the gray levels of the display image according to corresponding color offset information comprises:
performing, by an interpolator, an interpolation operation on first selected color offset information and second selected color offset information to generate an interpolated color offset information; and
generating, by a plurality of arithmetic circuits, each of a plurality of compensated gray levels by adding each of the gray levels of the display image with the interpolated color offset information.

16. The display image compensation method according to claim 11, wherein the first selected color is green.

17. The display image compensation method according to claim 11, further comprising:
based on a second selected color, generating, by a second offset information generator, second color offset information according to each of a plurality of gray levels of the display image corresponding to the second selected color; and
generating, by the color value compensator, each of the plurality of compensated gray levels by adjusting each of the gray levels of the display image according to the corresponding first color offset information and the second color offset information.
